(19) United States
(12) Patent Application Publication
(10) Pub. No.: US 2016/0294948 A1
(43) Pub. Date: Oct. 6, 2016

(54) SYSTEM FOR DATABASE, APPLICATION, AND STORAGE SECURITY IN SOFTWARE DEFINED NETWORK

(71) Applicant: ProphetStor Data Services, Inc., Taichung (TW)

(72) Inventor: Wen Shyen CHEN, Taichung (TW)

(73) Assignee: ProphetStor Data Services, Inc., Taichung (TW)

(21) Appl. No.: 14/677,214

(22) Filed: Apr. 2, 2015

(51) Int. Cl. H04L 29/08; H04L 29/06; G06F 17/30

(52) U.S. Cl. CPC H04L 67/1097; G06F 17/30545; H04L 63/10; G06F 17/30864; H04L 67/1095

(57) ABSTRACT

A system for database, application, and storage security in a Software Defined Network (SDN) is disclosed. The system includes: a SDN control server, a database monitoring server, a storage installation, and a storage security gateway server. The storage security gateway server can share loadings of the database monitoring server by watching the operating situation of the storage devices where the database monitoring server can not touch. Thus, security breach issues can be screened out. Storage security or even network security can be achieved. In addition, since the security breach issue screening jobs are distributed to one or more storage security gateway server, the architecture can work well even the SDN becomes larger and more and more nodes join in. Scalability is not an issue for the SDN.

### FIELD OF THE INVENTION

The present invention relates to a system for database, application, and storage security. More particularly, the present invention relates to a system for database, application, and storage security in a software defined network.

### BACKGROUND OF THE INVENTION

A network organizing technique that has become generally accepted is the Software-Defined Network (SDN). In principle, a SDN separates the data and control planes of networking devices, such as routers, packet switches, and LAN switches, with a well-defined Application Programming Interface (API) between the two. In contrast, in most large enterprise networks, routers and other network devices encompass both data and control planes, making it difficult to adjust the network infrastructure and operation to large-scale end systems, virtual machines, and virtual networks. OpenFlow specification is becoming the standard way for implementing an SDN.

Database or storage security is as important as SDN security. For a detailed explanation about operation of SDN security, please refer to FIG. 1. FIG. 1 shows a traditional database/application security scheme in a SDN 1 (the SDN 1 may also be a data network). In the SDN 1, there are usually a number of nodes, such as routers, switches, application servers, and hosts. In FIG. 1, for illustrative purpose, a router 2, two LAN switches 3 and 3′, three application servers 4′, 5, and 6, and two hosts 7 and 8 are depicted in the SDN 1. The router 2 links to internet 11. The host 7 links to the SDN 1 via the LAN switch 3. The application server 4′ further connects with a storage server 4 through a storage network 1′. The storage network 1′ may be a fiber channel network or an iSCSI network. It may link to the application server 5 so that the application server 5 can share the services from the storage server 4. The storage network 1′ may also have a switch 3″ (SAN switch) which connects the storage network 1′ with other storage network but not goes through Ethernet. The storage server 4 has a disk array 12 which has two Hard Disk Drives (HDDs), and a Solid State Drive (SSD). The storage server 4 has functions of server virtualization so that a cloud service 13, a mail database 14, and a video stream database 15 are created by sharing resources of the disk array 12. Applications provided by the application server 4′, for example, video streams, may come from the video stream database 15 mapping to physical volume(s) of the HDDs. The application server 6 has a HDD 16. It is a mail server and the HDD 16 is used as a database for emails and to store the related data. For operation of the SDN 1, a SDN control server 9 which comprises a SDN controller in the form of software (if SDN 1 is merely a data network, the SDN control server 9 is not necessary). The SDN control server 9 configures and enables network control to become directly programmable and the infrastructure can be abstracted from applications and network services.

For audit and security purpose, the SDN 1 further has a security unit 10 which listens to some or all ports of the nodes in the SDN 1. The security unit 10 checks packets transmitted in the SDN 1 for logging or tracking the related database activities. It can provide warnings when any abnormal states are found. Each node has its protective mechanism. Administrators can manipulate the protective mechanisms to adjust the nodes against the abnormal states. Thus, the SDN 1 can work smoothly and safely. The security unit 10 can also be an application over the SDN control server 9 rather than a standalone machine. 100051 Yet for security's sake, in the traditional SDN 1, there may be some problems. The most significant one is security breach. For example, assume the HDDs and the SSD in the disk array 12 came from the same maker. They are set to automatically replicate the contents of SSD to one HDD every day. Security breach may occur after the volume(s) of the HDD changes. Storage data is changed but the security unit 10 is not aware of this. The services provided by the storage server 4 which modify the volume content are left undetected. Similar situations of security breach may happen when one storage volume is mirrored to another volume, storage volume is wrongly assigned to another illegal user, or a combination of several iterations of the above. Of course, these issues may be solved by a single vendor solution. However, if the storages are “cross-platform” or “multi-platform”, the problem still exists.

Another problem is about scalability. As mentioned above, the security unit 10 is sideband sniffing to all or selected ports. If access requests from users (hosts) increase either in the SDN 1 or from the internet, to the application server 4′ which storage is provided by the storage server 4, the traffic in the SDN 1 is too large so that it is not possible to gather all packets and analyze them in time. Even with so-called “deep-packet inspection”, the architecture cannot sustain the sizing growth.

Therefore, in order to settle the aforementioned problems, a system for database, application, and storage security is desired. Especially, the system can have functions for software defined storage and work in a software defined network environment.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to settle the problems mentioned above, a system for database, application, and storage security in a Software Defined Network (SDN) is provided. The system includes: a SDN control server, for managing all nodes in the SDN; a database monitoring server, for receiving packets transmitted in the SDN, logging database or application activities from the packets, and tracking the database or application activities for audit and security; a storage installation, having a plurality of storage devices, for mapping Software Defined Storages (SDSs) to a volume or volumes of the storage devices, and providing application(s) and/or database service(s) according to requests from the nodes; and a storage security gateway server, having a storage security module, linked to the storage installation and a node in the SDN, for monitoring data traffic of the storage installation, communicating to the SDN control server, logging operations of the application(s) and database(s) onto the SDS, storing the operations of the application(s) and database(s), and providing an abnormal message which is triggered by an event to the database monitoring server.

According to the present invention, the storage security gateway server further comprises a SDS controller module, for assigning, provisioning and monitoring the storage devices in the storage installation. The storage security gateway server further communicates with the SDN control server through programmable ports thereof. The storage security gateway server further sends a record of changed volume(s) in the storage installation to a buffer storage, wherein the changed volume(s) is caused by the event. The storage security gateway server further takes snapshot of the changed volume(s) of the storage installation. The event is an unauthorized request asks for data replication, mirroring, or deleting, a request from an unauthorized host asks for access of the storage devices, or undefined data traffic between two storage devices in the storage installation, or between a storage in the storage installation and an external storage processes. The storage security gateway server stops requests of and processes for the event before or after the abnormal message is sent. The storage security module is application software run in the storage security gateway server or a hardware implementation.

Preferably, the storage devices are Hard Disk Drives (HDDs), Solid State Drives (SSDs), or a combination thereof. The storage security gateway server further links to the SDN via an Ethernet connection so that the storage security gateway server is able to communicate with the database monitoring server and the database monitoring server is able to inform the storage security gateway server to arrange new configuration of the storage devices for one application or database which is affected by the event.

The present invention also provides another system for database, application, and storage security in a SDN. The system includes a SDN control server, having database monitoring software, for managing all nodes in the SDN, receiving packets transmitted in the SDN, logging database or application activities from the packets, and tracking the database or application activities for audit and security; a storage installation, having a plurality of storage devices, for mapping Software Defined Storages (SDSs) to a volume or volumes of the storage devices, and providing application(s) and/or database service(s) according to requests from the nodes; and a storage security gateway server, having a storage security module, linked to the storage installation and a node in the SDN, for monitoring data traffic of the storage installation, communicating to the SDN control server, logging operations of the application(s) and database(s) onto the SDS, storing the operations of the application(s) and database(s), and providing an abnormal message which is triggered by an event to the database monitoring server.

According to the present invention, the storage security gateway server further comprises a SDS controller module, for assigning, provisioning and monitoring the storage devices in the storage installation. The storage security gateway server further communicates with the SDN control server through programmable ports thereof. The storage security gateway server further sends a record of changed volume(s) in the storage installation to a buffer storage, wherein the changed volume(s) is caused by the event. The storage security gateway server further takes snapshot of the changed volume(s) of the storage installation. The event is an unauthorized request asks for data replication, mirroring, or deleting, a request from an unauthorized host asks for access of the storage devices, or undefined data traffic between two storage devices in the storage installation, or between a storage in the storage installation and an external storage processes. The storage security gateway server stops requests of and processes for the event before or after the abnormal message is sent. The storage security module is application software run in the storage security gateway server or a hardware implementation.

Preferably, the storage devices are Hard Disk Drives (HDDs), Solid State Drives (SSDs), or a combination thereof. The storage security gateway server further links to the SDN via an Ethernet connection so that the storage security gateway server is able to communicate with the database monitoring server and the database monitoring server is able to inform the storage security gateway server to arrange new configuration of the storage devices for one application or database which is affected by the event.

The storage security module of the storage security gateway server can share loadings of the database monitoring server by watching the operating situation of the storage devices where the database monitoring server can not touch. Thus, security breach issues can be screened out. Storage security or even network security can be achieved. In addition, the database monitoring server can keep receiving packets while the security breach issue screening jobs are distributed to one or more storage security gateway server. The architecture can work well even the SDN becomes larger and more and more nodes join in. Scalability is not an issue.

### BRIEF DESCRIPTION OF THE DRAWINGS

FIG. 1 shows a traditional database/application security scheme in a software defined network.

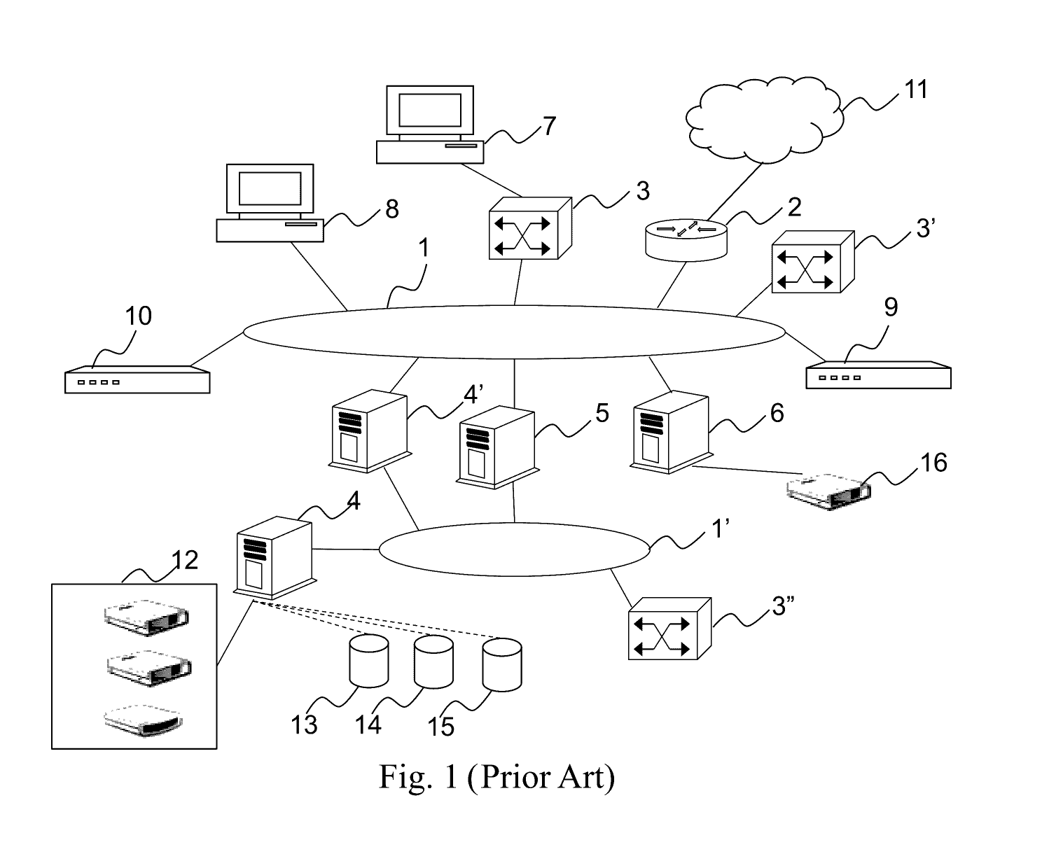

FIG. 2 is a system for database, application, and storage security in the software defined network according to the present invention.

FIG. 3 illustrates architecture of a storage security gateway server.

FIG. 4 is another system for database, application, and storage security in the software defined network according to the present invention.

FIG. 5 illustrates architecture of a software defined network control server.

### DETAILED DESCRIPTION OF THE PREFERRED EMBODIMENTS

The present invention will now be described more specifically with reference to the following embodiments.

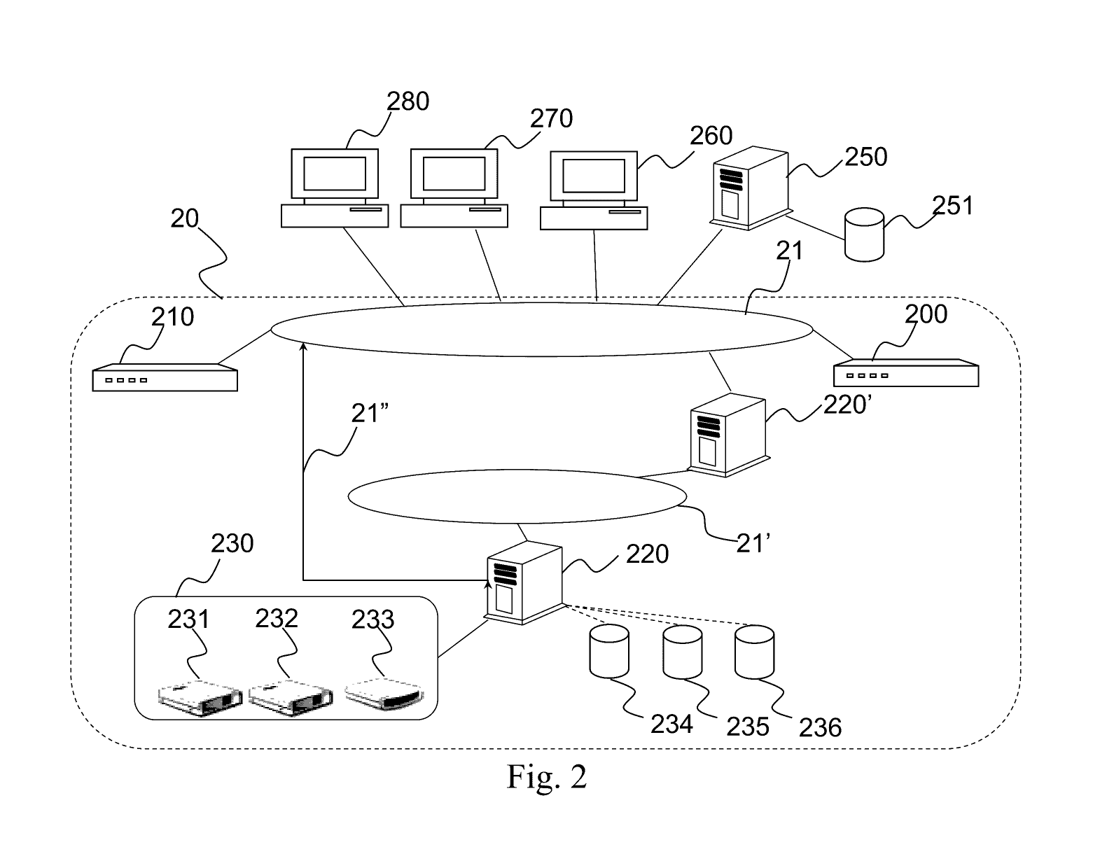

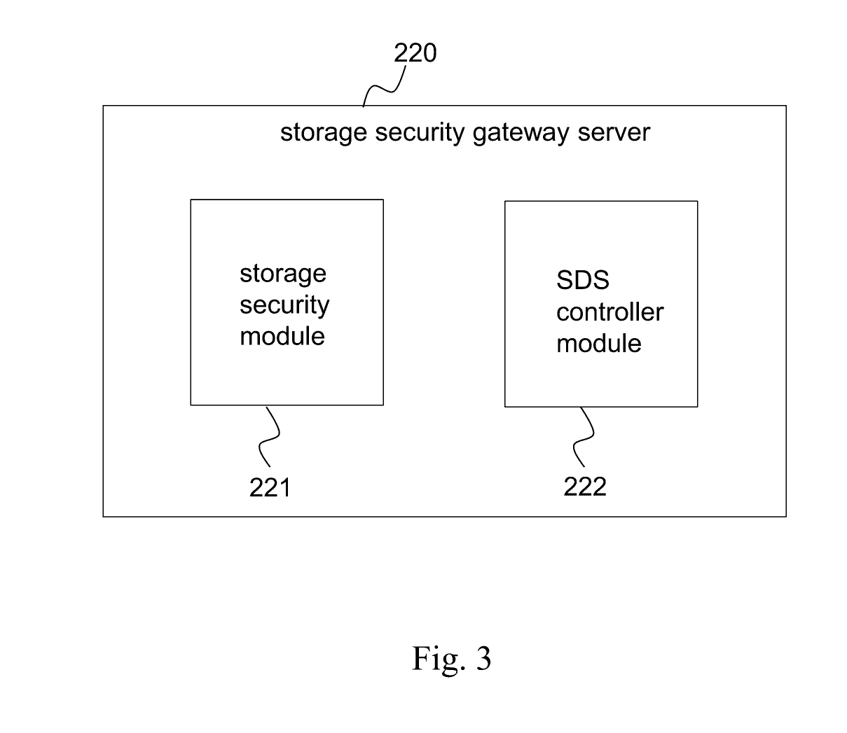

Please see FIG. 2 and FIG. 3. An embodiment of a system 20 for database, application, and storage security in a Software Defined Network (SDN) 21 according to the present invention is disclosed. Elements of the system 20 are enclosed within a dash-lined frame. The system 20 includes a SDN control server 200, a database monitoring server 210, a storage security gateway server 220, and a storage installation 230. In the SDN 21, there may be other nodes, such as hosts, routers, switches, and hubs. The system 10 can be applied to the SDN with a combination of the nodes. Below details functions of each element.

The SDN control server 200 is the key element for operating the SDN 21. It manages all nodes in the SDN 21 by assigning traffic of packets from and to the nodes. Although FIG. 2 only shows several hosts requesting access of the SDS assembly for application or database service, in fact, a SDN should have hundreds of thousands of hosts, linked by a number of switches and routers. FIG. 2 is only used for illustrative purpose. It focuses on how the system 20 functions and behaviors in the SDN 21.

The database monitoring server 210 can receive packets transmitted in the SDN 21. It is sideband attached to the SDN 21 and listens to all or partial ports of the nodes. Therefore, the database monitoring server 210 can log database or application activities from the packets, further tracking the database or application activities for audit and security purpose.

The storage security gateway server 220 has two modules, a storage security module 221 and a SDS controller module 222 as FIG. 3 illustrated. An application server 220′ is a node in the SDN 21, and is connected to storage security gateway server 220 through a storage network 21′. The application server 220′ can provide a number of services according to the requests from other nodes (hosts) in the SDN 21. The storage security gateway server 220 is further linked to the storage installation 230 directly and the SDN 21 via the application server 220′. As mentioned in the prior art, the storage network 21′ may be a fiber channel network or an iSCSI network. It may link to other application servers (not shown) so that other application server can share the services from the storage installation 230. The SDS controller module 222 can assign, provision and monitor storage devices in the storage installation 230. The storage devices may be all HDDs. They may be all SSDs. More commonly, the storage devices may be a combination of HDDs and SSDs. In this embodiment, there are three storage devices: a first HDD 231, a second HDD 232, and a SSD 233. Therefore, the storage security gateway server 220 plays a role of a storage control server. The storage installation 230 can be mapped as software defined storages from a volume or volumes of the storage devices, and be provided to application(s) and/or database service(s) according to requests from the nodes in the SDN 21. Thus, the application server 220′ can provide a specified service (application or database) out of the storage installation 230. For illustrative purpose, a cloud application 234, a mail database 235, and a video stream database 236 are used for the services.

It should be emphasized that although the three storage devices are used to describe the present invention, in practice, one storage installation may have hundreds or thousands of storage devices. The storage installation may also in the form of a RAID (Redundant Array of Inexpensive Disks).

With the storage security module 221, the storage security gateway server 220 can monitor data traffic of the storage devices in the storage installation 230. For example, there are two hosts, a first host 260 and a second host 270, as the nodes in the SDN 21. They are authorized to access the application server 220′ for email service, and the application server 220′ obtained the storage from the storage security gateway server 220. Of course, the two hosts are used for description. There should be a large amount of hosts (or other types of nodes) in the SDN 21. The first HDD 231 and the second HDD 232 are assigned for the mail database 235 to store the emails from the first host 260 and the second host 270. These data may be physically stored in specific volumes in the first HDD 231 and the second HDD 232 according to the policy of the storage security gateway server 220. For instance, the first host 260 is assigned to a first volume of the first HDD 231 and the second host 270 is assigned to a second volume of the second HDD 232. Each packet transmitted between the storages will be monitored by the storage security gateway server 220.

The storage security gateway server 220 further links to the SDN 21 via an Ethernet connection 21″ so that the storage security gateway server 220 is able to communicate with the database monitoring server 210 and the SDN control server 200. Of course, linkage between the storage security gateway server 220 and the SDN control server 200 may be available through the application server 220′ depending on the design of network. Meanwhile, it can log operations of the application(s) and database(s) which are onto the SDS (in this embodiment, email activities) and store the operations of the application(s) and database(s). Preferably, the storage security gateway server 220 communicates with the SDN control server 200 through programmable ports (of operating system or an application service) of the SDN control server 200.

It is very important that the storage security gateway server 220 can provide an abnormal message which is triggered by an event to the database monitoring server 210. Here, the event can be defined by an operation policy between the database monitoring server 210 and the storage security gateway server 220. The operation policy defines any abnormal (or unauthorized) conditions which happen in the storage devices, cannot be detected by the database monitoring server 210 by “sniffing” the packets, and cause security breach. For example, an unauthorized request from the first host 260 asks for data replication, data mirroring, or even data deleting in the second HDD 232. Actually, it may be a user getting other email services, such as backup his emails or remove all emails long time ago. Although the first host 260 is authorized to access the storage security gateway server 220, any unauthorized command or request should be noticed before it endangers the operation of the storage installation 230. The event may also be a request asking for access of an unauthorized storage device. For example, an unauthorized third host 280 wants to access the SSD 233. Besides, some default actions between the storage devices but not allowed by the operation policy can also be deemed as the event. For example, storage device providers may have their storages mutual data backup, e.g. the second HDD 232 and the SSD 233 backup data for each other. Undefined data traffic processes between two storage devices. Undefined data traffic not only exists between storage devices, but in one storage device in the storage installation 230 and an external storage, e.g. the SSD 233 and the a fourth HDD 251. If such data traffic is found by the storage security gateway server 220, the abnormal message should be triggered.

It should be emphasized that although there is only a storage security gateway server 220 with a storage installation 230 used in the SDN 21 in this embodiment, in fact, for any SDN, the number of storage installation is not limited. Several storage installations can work online and interact with the database monitoring server 210 at the same time. Besides, in addition to the administrator, the database monitoring server 210 can also inform the storage security gateway server 220 to arrange new configuration of the storage devices for one application or database which is affected by the event. Or following the operation policy, the storage security gateway server 220 can automatically arrange configuration of the storage devices and then feedback the change to the database monitoring server 210. For example, response time of the mail database 235 exceeds what is defined, the storage security gateway server 220 will switch the operating storage device from the second HDD 232 to the SSD 233 while the first HDD 231 is still working for the mail database 235.

In one example of the embodiment, the storage security gateway server 220 can further send a record of changed volume(s) in the storage installation 230 to a buffer storage, e.g. the fourth HDD 251 via an application server 250. In fact, the buffer storage can be any storage linked to the SDN 21, even a storage device inside the storage security gateway server 220 or any available storage device in the storage installation 230. The said changed volume(s) is caused by the event defined above. The record can be used for later analysis on the influence of the event. A rolling back may be taken by the storage security gateway server 220 if necessary. Then, the storage security gateway server 220 may take snapshot of the changed volume(s) of the storage installation 230 which can be used for rolling back the database later. To implement so, the storage security gateway server 220 can provide API (Application Programming Interface) to communicate with other database/application tool or module to protect the storage installation 230 as a whole. Such tool or module can help reconstruct the storage image and examine what other files or data in the storage installation 230 that may be illegally accessed. If the event is rated serious breach for storage security, the storage security gateway server 220 can stop the requests of the event and processes for the event before or after the abnormal message is sent. An urgent action can prevent the storage devices in the storage installation 230 from damage.

In practice, the storage security module 221 may be application software run in the storage security gateway server 220 or a hardware implementation. It makes the functions of the storage security gateway server 220 can be separated into two machines. Namely, there may be two servers linked to the storage installation 230. One is for operating the storage installation 230 and provides services (applications or database) from the storage installation 230 while the other is in charge of storage security.

From the description above, it is obvious that the storage security module 221 of the storage security gateway server 220 can share loadings of a traditional database monitoring server by watching the operating situation of the storage devices in the storage installation 230 where the traditional database monitoring server can not touch. Thus, security breach issues can be screened out. Storage security or even network security can be achieved. In addition, the database monitoring server 210 can keep receiving packets while the security breach issue screening jobs are distributed to one or more storage security gateway server 220. The architecture can work well even the SDN 21 becomes larger and more and more nodes (e.g. hosts) join in. Scalability is not a challenge to the system 10.

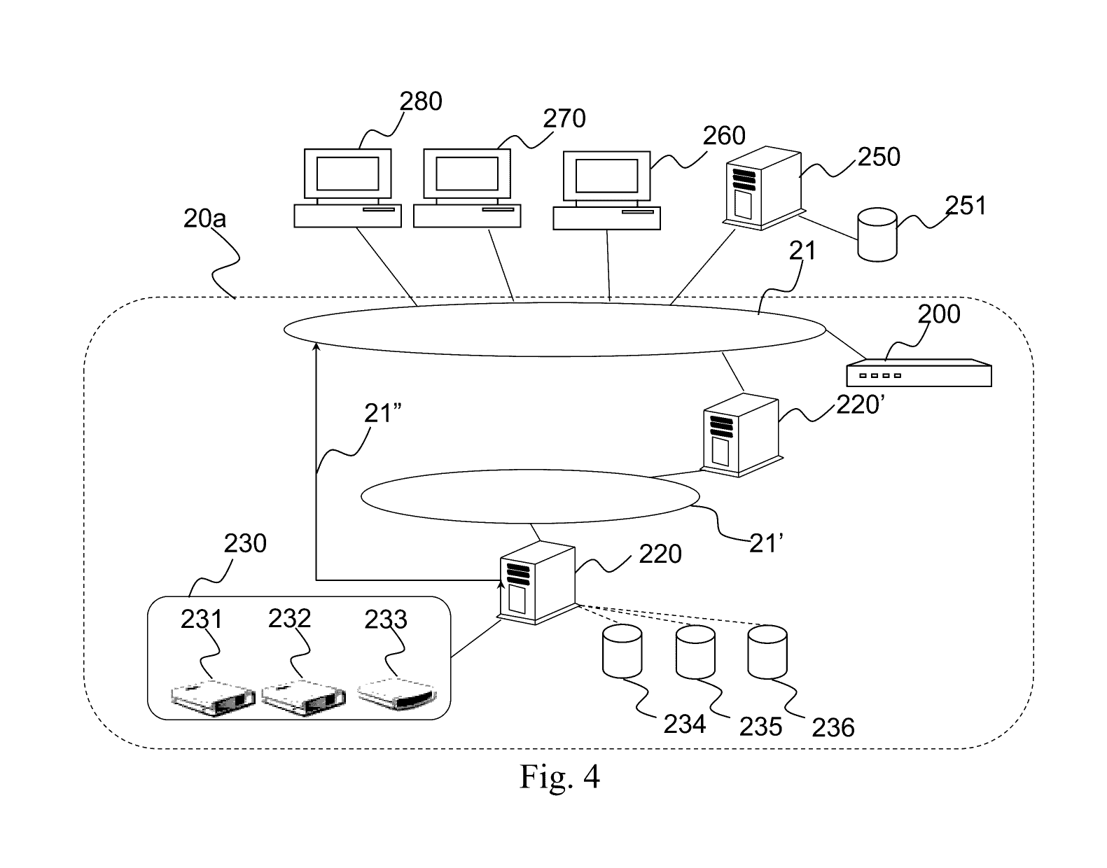

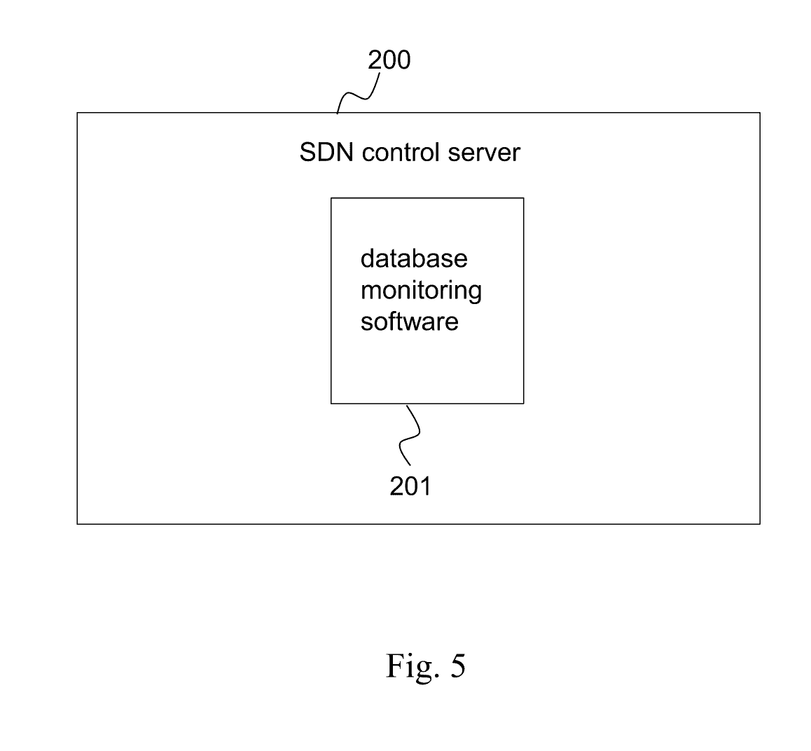

According to the spirit of the present invention, the database monitoring server 210 is not necessary to be a standalone machine. It can be software working in the operating system of the SDN control server. In this embodiment, the architecture is illustrated in FIG. 4 and a detailed explanation of the SDN control server is shown in FIG. 5. By using the same elements in FIG. 2, a system 20a is composed of a SDN control server 201, the storage security gateway server 220, and the storage installation 230. Functions and operation of the storage security gateway server 220 and the storage installation 230 are the same as what disclosed above. It is not to repeat it again. The SDN control server 201 has a database monitoring software. Thus, the SDN control server 201 can not only manage all nodes in the SDN 21, but also can receive packets transmitted in the SDN 21, log database or application activities from the packets, and tracking the database or application activities for audit and security. In other words, the SDN control server 201 incorporates the SDN control server 200 and the database monitoring server 210 in the previous embodiment.

The present invention provides several advantages. The previous database performance tuning tools detects the commands down to the storage and the response time. The database administrator, after analyzing the logging/tracking data with experience and plenty of time and efforts, tries to relocate the database records and/or the block size manually to increase the performance. With the new architectures proposed, the storage security gateway server communicates with the SDN control server, and receives the analysis results. The storage security gateway server can perform relocating the database onto different storage tiers (such as from the HDD to SSD) or other operations automatically based on the operation policy. The storage security gateway server can be used as a QoS tool to match the SDS or SDN requirement. In addition, the present invention enhances instant data virtual reality (whole system image and environment). With the snapshot capability in the SDS and operation policy defined from the storage security gateway server, it is able to construct data virtual reality instantly for a concerned time point in question, instead of having only the most recent system environment and data log for rolling back.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A system for database, application, and storage security in a Software Defined Network (SDN), comprising:
a SDN control server, for managing all nodes in the SDN;
a database monitoring server, for receiving packets transmitted in the SDN, logging database or application activities from the packets, and tracking the database or application activities for audit and security;
a storage installation, having a plurality of storage devices, for mapping Software Defined Storages (SDSs) to a volume or volumes of the storage devices, and providing application(s) and/or database service(s) according to requests from the nodes; and
a storage security gateway server, having a storage security module, linked to the storage installation and a node in the SDN, for monitoring data traffic of the storage installation, communicating to the SDN control server, logging operations of the application(s) and database(s) onto the SDS, storing the operations of the application(s) and database(s), and providing an abnormal message which is triggered by an event to the database monitoring server.

2. The system according to claim 1, wherein the storage security gateway server further comprises a SDS controller module, for assigning, provisioning and monitoring the storage devices in the storage installation.

3. The system according to claim 1, wherein the storage security gateway server further communicates with the SDN control server through programmable ports thereof.

4. The system according to claim 1, wherein the storage security gateway server further sends a record of changed volume(s) in the storage installation to a buffer storage, wherein the changed volume(s) is caused by the event.

5. The system according to claim 4, wherein the storage security gateway server further takes snapshot of the changed volume(s) of the storage installation.

6. The system according to claim 1, wherein the event is an unauthorized request asks for data replication, mirroring, or deleting, a request from an unauthorized host asks for access of the storage devices, or undefined data traffic between two storage devices in the storage installation, or between a storage in the storage installation and an external storage processes.

7. The system according to claim 1, wherein the storage security gateway server stops requests of and processes for the event before or after the abnormal message is sent.

8. The system according to claim 1, wherein the storage security module is application software run in the storage security gateway server or a hardware implementation.

9. The system according to claim 1, wherein the storage devices are Hard Disk Drives (HDDs), Solid State Drives (SSDs), or a combination thereof.

10. The system according to claim 1, wherein the storage security gateway server further links to the SDN via an Ethernet connection.

11. system for database, application, and storage security in a SDN, comprising:
a SDN control server, having database monitoring software, for managing all nodes in the SDN, receiving packets transmitted in the SDN, logging database or application activities from the packets, and tracking the database or application activities for audit and security;
a storage installation, having a plurality of storage devices, for mapping Software Defined Storages (SDSs) to a volume or volumes of the storage devices, and providing application(s) and/or database service(s) according to requests from the nodes; and
a storage security gateway server, having a storage security module, linked to the storage installation and a node in the SDN, for monitoring data traffic of the storage installation, communicating to the SDN control server, logging operations of the application(s) and database(s) onto the SDS, storing the operations of the application(s) and database(s), and providing an abnormal message which is triggered by an event to the database monitoring server.

12. The system according to claim 11, wherein the storage security gateway server further comprises a SDS controller module, for assigning, provisioning and monitoring the storage devices in the storage installation.

13. The system according to claim 11, wherein the storage security gateway server further communicates with the SDN control server through programmable ports thereof.

14. The system according to claim 11, wherein the storage security gateway server further sends a record of changed volume(s) in the storage installation to a buffer storage, wherein the changed volume(s) is caused by the event.

15. The system according to claim 14, wherein the storage security gateway server further takes snapshot of the changed volume(s) of the storage installation.

16. The system according to claim 11, wherein the event is an unauthorized request asks for data replication, mirroring, or deleting, a request from an unauthorized host asks for access of the storage devices, or undefined data traffic between two storage devices in the storage installation, or between a storage in the storage installation and an external storage processes.

17. The system according to claim 11, wherein the storage security gateway server stops requests of and processes for the event before or after the abnormal message is sent.

18. The system according to claim 11, wherein the storage security module is application software run in the storage security gateway server or a hardware implementation.

19. The system according to claim 11, wherein the storage devices are Hard Disk Drives (HDDs), Solid State Drives (SSDs), or a combination thereof.

20. The system according to claim 11, wherein storage security gateway server further links to the SDN via an Ethernet connection.
